(19) United States
(12) Patent Application Publication
(10) Pub. No.: US 2015/0346703 A1
(43) Pub. Date: Dec. 3, 2015

(54) STATE OBSERVERS

(71) Applicant: Infineon Technologies AG, Neubiberg (DE)

(72) Inventors: Dirk Hammerschmidt, Villach (AT); Andrei Daniel Basa, Bucharest (RO); Alexandra Iosub, Iasi (RO)

(73) Assignee: Infineon Technologies AG, Neubiberg (DE)

(21) Appl. No.: 14/287,841

(22) Filed: May 27, 2014

(51) Int. Cl. G05B 17/02; G06F 17/10

(52) U.S. Cl. CPC G05B 17/02; G06F 17/10

(57) ABSTRACT

State observers and systems using wave digital filter models are discussed.

### TECHNICAL FIELD

The present application relates to state observers, to control systems usable for controlling devices including a state observer and to corresponding methods.

### BACKGROUND

In many applications, a controller may control a controlled device, for example an electronic device, a mechanic device or an electromechanical device, by sending one or more control signals to the controlled device. In some cases, the controller may generate the one or more control signals based on a feedback from the controlled device, for example based on an output signal of the controlled device.

However, in some cases it is desirable to generate the one or more control signals not only based on feedback from the device, but also based on one or more internal states of the controlled device, for example internal voltages or internal currents. Such internal states may be difficult to measure.

Therefore, in some cases a state observer is used which is an entity, typically computer-implemented, that provides an estimate of one or more internal states of the controlled device. For such a computer implementation usually the controlled device, which may be a continuous time system, has to be approximated by discrete time equations. For cases where the controlled device includes multiple dynamic effects that interact with each other like a transistor and a load comprising e.g. capacitors and inductors, additional delays may be introduced. Such additional delays may cause parameter (e.g. resistor, inductor and capacitor values) dependent stability problems of a parameterized model of the controlled device, the model being used to implement the state observer, even if the model represents only a passive system.

### BRIEF DESCRIPTION OF THE DRAWINGS

FIG. 1 is a block diagram of a system according to an embodiment.

FIG. 2 is a block diagram of a system according to a further embodiment.

FIG. 3 is a flowchart illustrating a method according to an embodiment.

FIG. 4 is an example system according to an embodiment.

FIG. 5 is a circuit diagram illustrating an RLC network according to an embodiment.

FIGS. 6, 7A-7C, 8A-8C, 9A-9C, 10A, 10B, 11A, 11B, 12A, 12B, 13A, 13B, 14A, 14B, 15A, and 15B illustrate various components for building a state observer according to an embodiment.

FIGS. 16A and 16B illustrate an implementation of a wave digital filter model for a state observer for the RLC network of FIG. 5, according to an embodiment.

FIGS. 17A-17G, 18A, 18B, 19, 20A-20C, 21A-21C, 22, 23, and 24A-24D illustrate implementation of transistors and transistor circuits using wave digital filters.

FIG. 25 illustrates a controlled device usable in some embodiments.

FIG. 26 illustrates a wave digital filter model for a state observer for the device of FIG. 25 according to an embodiment.

FIG. 27 illustrates simulation results illustrating operation of some embodiments.

### DETAILED DESCRIPTION

In the following, various embodiments will be described in detail referring to the attached drawings. It should be noted that these embodiments are given for illustration purposes only and are not to be construed as limiting. For example, while embodiments may be described herein and shown in the drawings as comprising a plurality of features or elements, in other embodiments some of these features or elements may be omitted and/or may be replaced by alternative features or elements. In yet other embodiments, additional features or elements apart from the ones explicitly described or shown may be provided.

Features or elements from different embodiments may be combined to form further embodiments. Moreover, it should be noted that connections or couplings shown in the drawings or described herein may be implemented as direct connections or couplings, i.e. connections or couplings without additional intervening elements, or as indirect connections or couplings, i.e. connections or couplings comprising one or more intervening elements, as long as the basic function of the connection or coupling, for example to transmit a certain kind of information or a certain kind of signal, is essentially preserved. Connections or couplings may be implemented as wire-based connections or couplings, wireless connections or couplings or mixtures thereof.

In some embodiments, state observers may be implemented using wave digital filters (WDFs), e.g. a WDF model of a controlled device. In some embodiments, the wave digital filters may be implemented using a plurality of n port adaptors, for example three port adaptors. In some embodiments, using such a state observer implemented using wave digital filters, internal states of a controlled device may be estimated and used in controlling the controlled device.

In some embodiments, the wave digital filters may model RLC (Resistor-Inductivity-Capacitor) components and/or components including transistors. In some embodiments, the transistors may be modeled by wave digital filters using a small signal model of the transistors.

In some embodiments, using wave digital filters a stable model for a state observer with small delays with respect to a controlled device which is modeled by the state observer may be implemented.

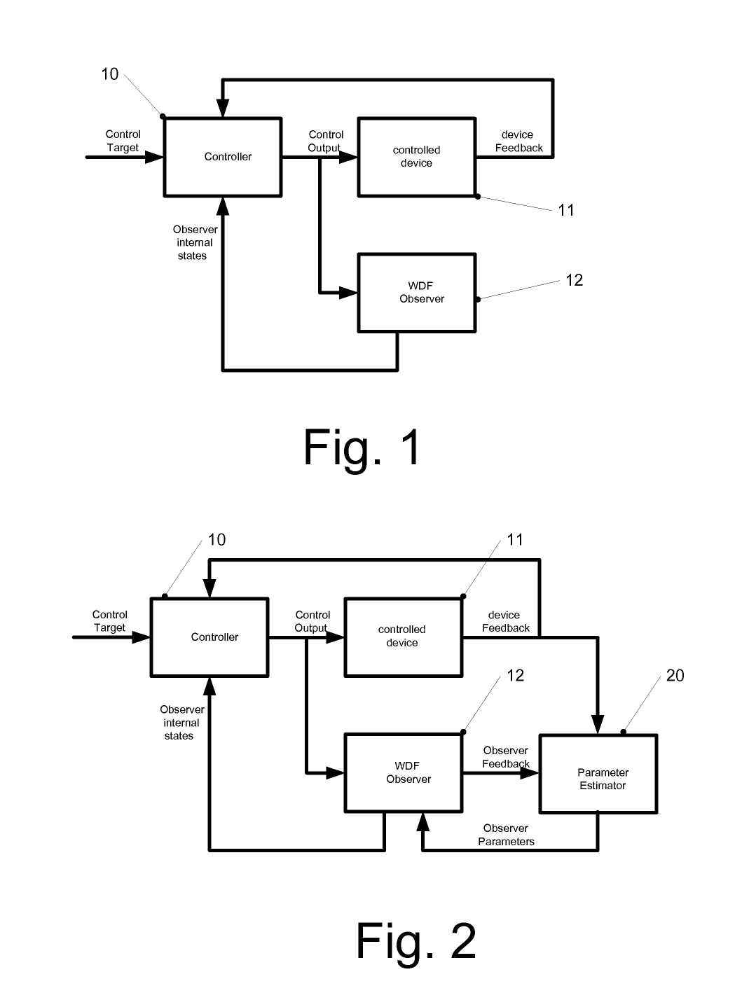

Turning now to the Figures, FIG. 1 illustrates a system according to an embodiment. The system of FIG. 1 comprises a controller 10 controlling a controlled device 11 via a control output signal or vector, labeled “Control Output” in FIG. 1. An implementation of controller 10 may depend on the nature of controller 10. Generally, controller 10 may be implemented in software, hardware, firmware or combinations thereof. For example, controller 10 may comprise a voltage regulator, an adaptive PID controller, a state space controller or any other type of conventional controller. Controlled device 11 may for example comprise an electronic circuit, a mechanic device or an electromechanical device, but is not limited to these examples. Controlled device 11 may be a real device or also a simulated device, for example a VHDL simulated device. The control output signal may for example be a voltage signal or a current signal. In some embodiments, more than one control output signal may be provided. In some embodiments, the control output signal may for example be a supply voltage for controlled device 11, the supply voltage being variable by controller 10. In the embodiment of FIG. 1, controller 10 may receive a control target indicating a desired result of the control. Furthermore, controller 10 may receive a device feedback from controlled device 11, for example an output signal of controlled device 11 or any other kind of feedback, e.g. a sensor measurement of a mechanical device. For example, in some embodiments, the control output may be adjusted to obtain a certain value or property of the device feedback, for example a desired signal strength or signal-to-noise ratio, as indicated by the control target.

Furthermore, the system of FIG. 1 comprises a state observer 12 according to an embodiment, which is implemented based on wave digital filters (WDFs). State observer 12 may for example be implemented as VHDL synthesized digital hardware or as a program running on one or more microprocessors. The wave digital filters model controlled device 11 or parts thereof. For example, state observer 12 receives the control output signal from controller 10 and models the behavior of controlled device 11 in response to the control output signal. Using state observer 12, internal states of the controlled device, for example internal currents or internal voltages, may be estimated and fed as observer-internal states to controller 10. Controller 10 then may additionally generate the control output signal based on these estimated internal states. For example, regulation of a voltage may take stored energy in inductors and/or capacitances of the controlled device into account as an example for internal states.

In some embodiments, state observer 12 may be designed based on knowledge of controlled device 11. In some embodiments, additionally state observer 12 may be adapted to match the behavior of controlled device 11 more closely, for example to account for temperature variations, process variations, installation in different environments or any other external influences which may cause controlled device 11 to deviate from an “ideal” behavior based on its design. An example for such an embodiment will next be discussed with reference to FIG. 2. Controller 10, controlled device 11 and state observer 12 of the embodiment of FIG. 2 essentially correspond to controller 10, controlled device 11 and state observer 12 of the embodiment of FIG. 1, and their function and interaction as described with reference to FIG. 1 may also apply to the embodiment of FIG. 2. Additionally, the embodiment of FIG. 2 comprises a parameter estimator 20. Parameter estimator 20 may be implemented in software, hardware, firmware or combinations thereof. For example, parameter estimator 20 may be implemented together with state observer 12 as a program executed by one or more microprocessors or other programmable devices or as hardware.

Parameter estimator 20 receives the device feedback from controlled device 11, for example an output signal of controlled device 11. Furthermore, parameter estimator 20 receives an observer feedback from state observer 12, for example an output signal of the model of controlled device used in state observer 12 which corresponds to the device feedback received from controlled device 11. Parameter estimator 20 then adjusts observer parameters, for example parameters of the wave digital filters like wave resistances, to reduce or minimize differences between the device feedback and the observer feedback. Such wave resistances may correspond to parameters of controlled device like inductances, capacitances or resistances. In other words, parameter estimator 20 adjusts the observer parameters to improve the modeling of the controlled device 11 by the wave digital filters in some embodiments. For adjusting the observer parameter, any conventional algorithm, for example any conventional optimization algorithm, for example a simple Newtonian algorithm or fitting algorithms, may be used. Other techniques may be applied as well. In some embodiments, such adjusted parameters may also be fed to controller 10 as estimated internal states, to be used for generating the control output signal or vector. In other words, this may improve the “knowledge” of the controller regarding actual parameters of the controlled device, which may be used to enhance the controlling.

FIG. 3 is a flowchart illustrating a method according to an embodiment. While the method of FIG. 3 is shown and will be described as a series of acts or events, the order in which these acts or events are performed is not to be construed as limiting. For example, acts or events may be performed in a different order than shown, or some of the acts or events may be performed in parallel, for example by different parts of a system, circuit or device. Acts or events may be performed repeatedly to implement a control loop. The method of FIG. 1 may be implemented using the system of FIG. 1 or the system of FIG. 2, but may also be applied to other systems or devices.

At 30, the method of FIG. 3 comprises generating a control signal to control a device based on a feedback from the device and estimated internal states of the device. The feedback of the device may for example comprise an output signal of the device. The device may for example be an electronic device or circuit, a mechanical device or an electromechanical device. The estimated internal states may for example comprise estimated internal voltages or currents at or through components of the device.

At 31, the method comprises generating a device feedback based on the control signal. In other words, the device feedback like an output signal of the device may change in response to the control signal generated at 30.

At 32, the method of FIG. 3 comprises estimating internal states of the device based on the control signal using a wave digital filter model of the device. In other words, the behavior of the device in response to the control signal may be simulated using wave digital filter, and based on the simulation estimates of internal states may be obtained. After 32, the method of FIG. 3 continues at 30 with the new values of the device feedback and internal states provided at 31 and 32, respectively. Thus, a control loop for controlling the device is implemented.

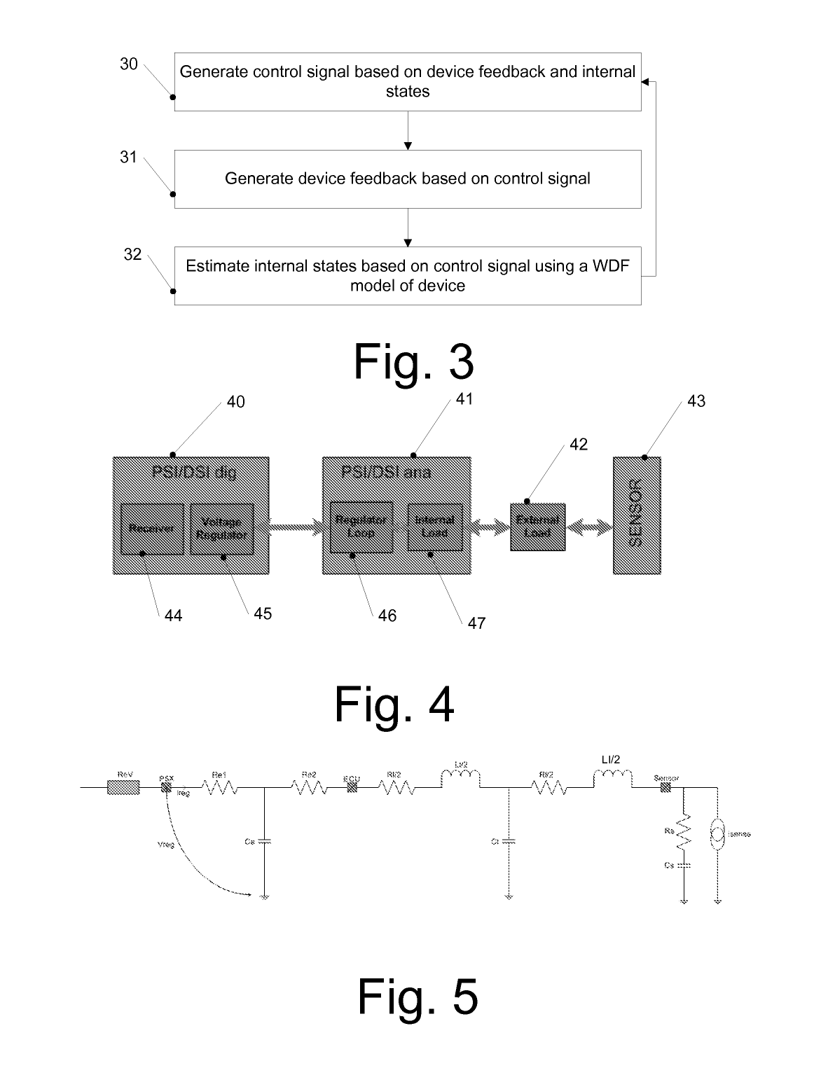

To illustrate the concepts and techniques explained with reference to FIGS. 1-3 further, with reference to FIGS. 4-27 implementations of wave digital filter models for example systems will be discussed in detail. This, however, only serves for further illustration of concepts and techniques disclosed herein and is not to be construed as limiting, as the concepts and techniques disclosed herein may be applied to a broad variety of systems, and the specific system illustrated below serves merely as an example.

FIG. 4 illustrates an example device to which techniques and concepts disclosed herein may be applied, according to some embodiments. The example device of FIG. 4 comprises a sensor system, for example based on a PSI5 (peripheral sensor interface 5) and/or a DSI3 (distributed system interface) sensor device. The device of FIG. 4 comprises a digital part 40 and an analog part 41 being coupled to a sensor 43 via an external load 42, for example a wire harness. Digital part 40 comprises a receiver 44 to receive and process signals from the sensor and a digital voltage regulator part 45, which together with a regulator loop 46 in analog part 41 serves for controlling a sensor voltage and is an example for a controller like controller 10 of FIGS. 1 and 2. The voltage regulator thus formed may be influenced by an internal load 47 which may represent internal resistances, capacitances etc. of analog part 41 and by external load 42. Digital part 40 and analog part 41 in some embodiments may be implemented as a system-on-chip (SoC). Analog part 41 may for example comprise digital-to-analog converters and/or analog-to-digital converters to communicate with digital part 40 and convert between digital signals used in digital part 40 and analog signals used in analog part 41 and being output to sensor 43 or received from sensor 43 via external load 42.

FIG. 5 is a circuit representation of internal load 47 and external load 42 as well as sensor 43, i.e. a representation of components attached to the voltage regulator and regulator loop 45, 46. ReV in FIG. 5 represents a voltage source outputting a voltage from regulator loop 46. A node P5X of FIG. 5 corresponds to an output node of regulator loop 46 of FIG. 4. Re1 corresponds to a first resistance of internal load 47, and Ce corresponds to an internal capacitance of internal load 47. A voltage drop across Re1 and Ce as indicated in FIG. 5 corresponds to an actual regulated voltage Vreg output by regulator loop 46. Re2 designates a further internal resistance of internal load 47. A node labeled ECU in FIG. 5 corresponds to an output of analog part 41. External load 42 in the circuit diagram of FIG. 5 is represented by two resistors labeled RI/2, two inductances labeled LI/2 and a capacitance labeled CI. Depending on the connection represented by external load 42, for example a wire harness, other representations may apply in other embodiments. A node labeled “sensor” in FIG. 5 represents an interface between external load 42 and sensor 43.

Sensor 43 in the circuit diagram of FIG. 5 is represented by a resistor Rs and a capacitor Cs representing internal resistance and capacitance of sensor 43. Furthermore, sensor 43 is represented by a current source Isense, a current output by this current source essentially corresponding to a sensor signal (then modified by internal resistor Rs and internal capacitor Cs).

In the following, modeling the circuit of FIG. 5 using wave digital filters to implement a state observer like state observer 12 of FIGS. 1 and 2 will be discussed. Prior to an illustrative example for implementing a model of the circuit of FIG. 5 using wave digital filters, some background regarding wave digital filters will be discussed. This discussion will be made brief for conciseness' sake, as any conventional implementation techniques of wave digital filters may be used.

In wave digital filters, connections of elements are modeled by transmission lines, and signals are modeled using a forward traveling wave a(x) and a backward traveling wave b(x). The forward traveling wave and the backward traveling wave are linear combinations of voltage and current and vice versa according to:

$$\begin{matrix}a ( x ) = v ( x ) + {R}_{L} i ( x ) & ( 1 ) \\ b ( x ) = v ( x ) - {R}_{L} i ( x ) & ( 2 ) \\ v ( x ) = \frac{a ( x ) + b ( x )}{2} & ( 3 ) \\ i ( x ) = \frac{a ( x ) - b ( x )}{2 {R}_{L}} & ( 4 )\end{matrix}$$

Therefore, when for example implementing an RLC network like the circuit of FIG. 5, network equations of the network coupled by transmission lines are essentially solved by means of waves. In equations (1) to (4), R_{L} represents a wave impedance. v(x) corresponds to a voltage at a point x, and i(x) corresponds to the current at point x. Equations (1) and (2) represent forward traveling waves and backward traveling waves as linear combinations of voltage and current, and equations (3) and (4) represent voltage and current as linear combinations of forward traveling wave and backward traveling wave.

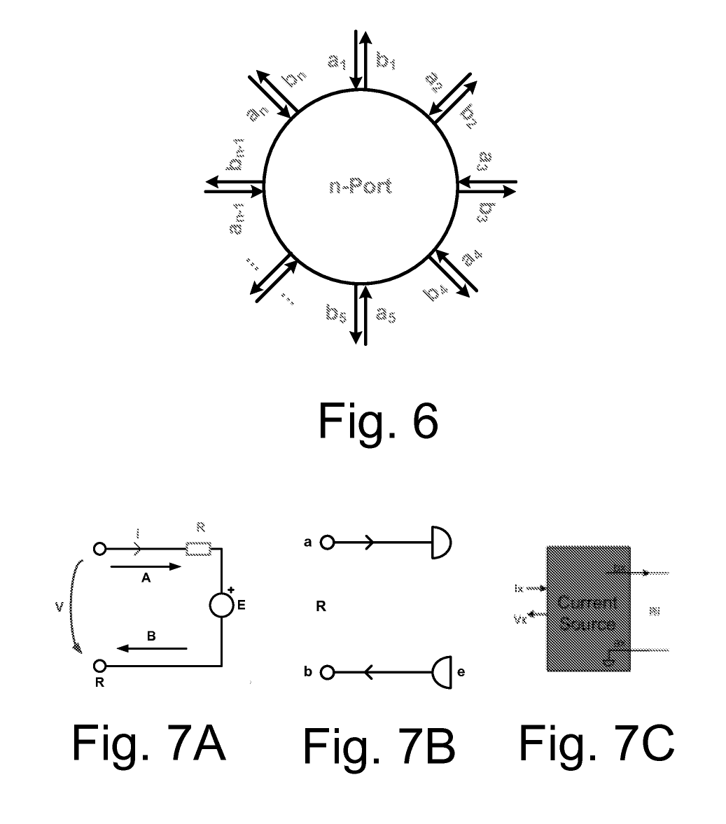

To build a wave digital filter model which connects various elements adaptors may be used that e.g. define how a forward wave at one port of the adaptor contributes to waves at other ports of the adaptor. A generic n-port adaptor is shown in FIG. 6, aᵢ, i=1 . . . n represents incoming (forward traveling) waves, and bᵢ represent reflected (backward traveling) waves. The generic n-port adaptor may be described according to

\vec{b}=\vec{S}·\vec{a} (5)

wherein \vec{b} is a vector formed by the bᵢ, \vec{a} is a vector formed by the aᵢ, and \vec{S} is an n×n scattering matrix. Such a generic n-port adaptor thus requires n² multiplications.

Next, some basic elements usable for modeling the circuit of FIG. 5 using wave digital filters will be discussed. FIGS. 7A to 7C illustrate the implementation of a current source. FIG. 7A shows a schematic circuit diagram of a current source having an internal resistance R. As shown in FIG. 7B, in a wave representation such a current source terminates a forward traveling wave a and transmits a new wave b. The values of the waves may be determined as illustrated with respect to equations (1)-(4). FIG. 7C shows a symbol used for such a current source in the following.

A VHDL code representation of such a current source is shown below:

entity wdf_current_source is
generic(

Ts : real := 0.013889e−06; -- system clock period
Ri : real := 10.0
);

| port( | |
|---|---|
| Ii : in analog_t; | --current input |

| | |
|---|---|
| Vo | : out analog_t; |

| | |
|---|---|
| ax : in real; | --forward traveling wave |
| bx : out real | --backward traveling wave |

);

end wdf_current_source;
architecture behav of wdf_current_source is
signal bx_s : real := 0.0;
signal Vo_s : analog_t := 0.0;
begin
bx <= bx_s;
Vo <= Vo_s;
bx_s <= Ri * real(Ii) ;
--calculate the voltage drop:
Vo_s <= analog_t((ax + bx_s)/2.0);

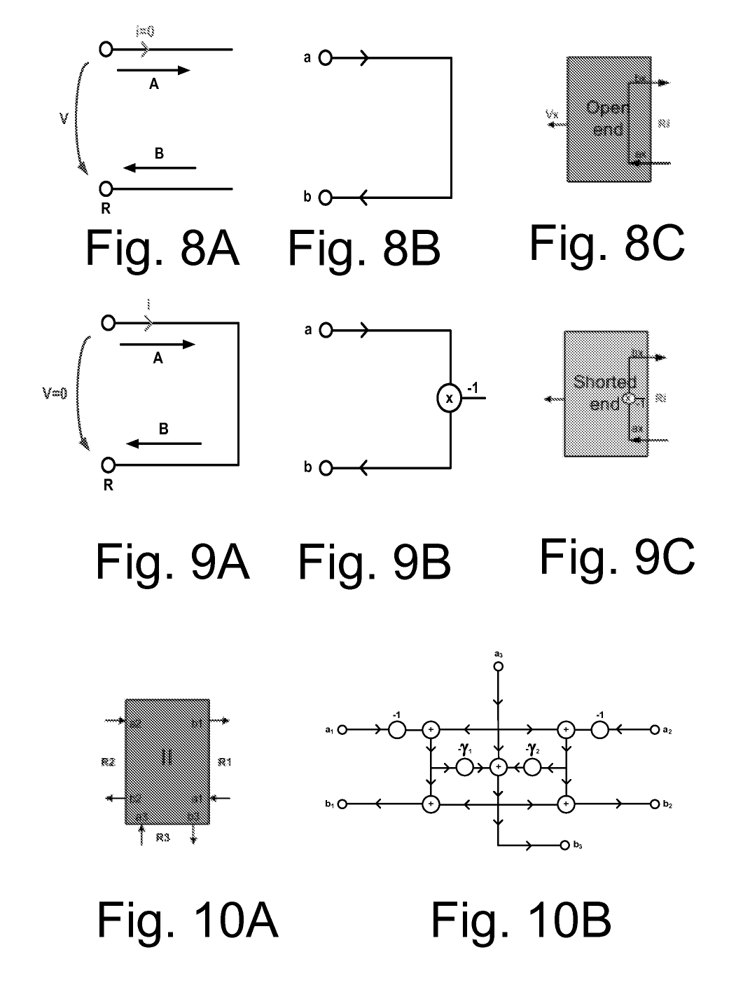

In FIGS. 8A-8C, modeling of an open end is shown. FIG. 8A shows a schematic circuit diagram, FIG. 8B shows a wave diagram and FIG. 8C shows a symbol used herein to represent an open end. Here, the forward traveling wave a is reflected to form the backward traveling wave b, as over an open end no current may flow. From equation (4) from i(x)=0 a(x)=b(x) follows.

FIGS. 9A-9C illustrate implementation of a shorted end. Here, the voltage drop is zero, and from equation (3) with v(x)=0 a(x)=−b(x), i.e. an inversion of the wave follows. FIG. 9A shows a schematic circuit diagram, FIG. 9B shows a wave diagram, the multiplication with −1 corresponding to the inversion of the wave, and FIG. 9C shows a symbol used herein.

Elements like the ones explained above with reference to FIGS. 7-9 and as will be described later with reference to FIGS. 13-15 may be interconnected with each other using n-port adaptors as generically explained above with reference to FIG. 6. A type of n-port adaptor used in the following explanations is a three-port parallel adaptor. Another type is a three-port serial adaptor. A parallel adaptor may be used to model a parallel coupling of elements, while a serial adaptor may be used to model a serial coupling. Examples for such specific adaptors will be described next with reference to FIGS. 10-12.

FIG. 10A shows a symbol used for a three-port parallel adaptor, i.e. an adaptor used for modeling a parallel connection. FIG. 10B shows an example implementation scheme. The scheme of FIG. 10B uses multiplications with −1, multiplications with −γ₁ and −γ₂ as well as additions to link the incoming waves a₁, a₂ and a₃ with the outgoing waves b₁, b₂, b₃. In FIG. 10A, R1, R2 and R3 designate wave resistances of the three ports. γ and γ₂ may be calculated as follows:

wherein G₁=1/R1, G₂=1/R2 and G₃=1/R3.

$$\begin{matrix}{γ}_{1} = \frac{2 {G}_{1}}{{G}_{1} + {G}_{2} + {G}_{3}} & ( 5 ) \\ {γ}_{2} = \frac{2 {G}_{2}}{{G}_{1} + {G}_{2} + {G}_{3}} & ( 6 )\end{matrix}$$

A possible VHDL code for such a three-port parallel adaptor is shown below:

-- define propagation costants
gama1 <= (2.0 / R1)/((1.0/R1) + (1.0/R3)) when ((R1 /= −
1.0e+308 and R1 /= −5.0e+307 and R1 /= 0.0) and

and (R3 /= −1.0e+308 and R3 /= −5.0e+307 and R3

/= 0.0));
gama2 <= (2.0 / R2)/((1.0/R1) + (1.0/R2) + (1.0/R3)) when
((R1 /= −1.0e+308 and R1 /= −5.0e+307 and R1 /= 0.0) and

and (R3 /= −1.0e+308 and R3 /= −5.0e+307 and R3

/= 0.0));
-- compute node equations
s1 <= a3_s − a1_s when ((a1 /= −1.0e+308 and a1 /= −
5.0e+307) and (a3 /= −1.0e+308 and a3 /= −5.0e+307)) else
0.0;
s2 <= a3_s − a2_s when ((a2 /= −1.0e+308 and a2 /= −
5.0e+307) and (a3 /= −1.0e+308 and a3 /= −5.0e+307)) else
0.0;
s56 <= (a3_s − (gama1 * s1) − (gama2 * s2)) when ((s1 /= −
1.0e−308 and s1 /= −5.0e+307) and (s1 /= −1.0e+308 and s
-- set outputs
b3 <= s56 when (s56 /= −1.0e+308 and s56 /= −5.0e+307)
else 0.0;
b1 <= s1 + s56 when ((s1 /= −1.0e+308 and s1 /= −5.0e+307)
and (s56 /= −1.0e+308 and s56 /= −5.0e+307)) else 0.0;
b2 <= s2 + s56 when ((s2 /= −1.0e+308 and s2 /= −5.0e+307)
and (s56 /= −1.0e+308 and s56 /= −5.0e+307)) else 0.0;
-- END of code

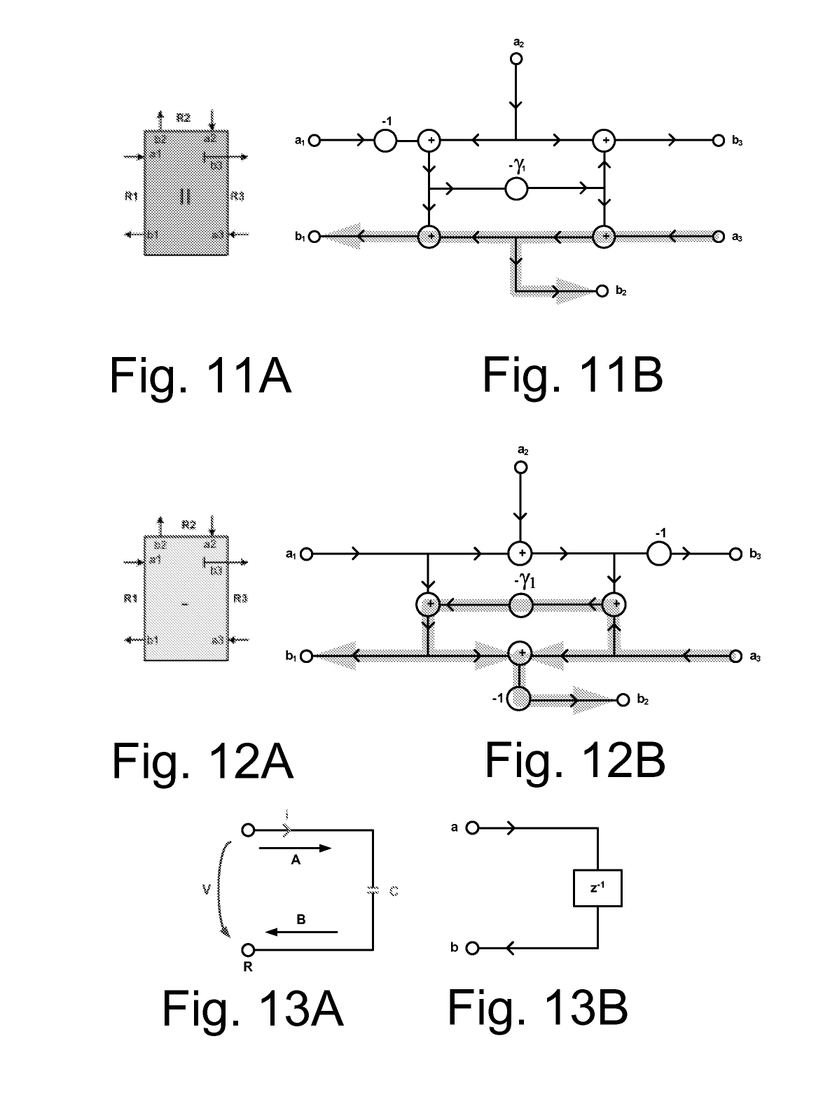

In some cases, it may be possible to simplify the implementation of a three-port adaptor in case matched terminations may be provided. For example, for ports connected to elements like current sources, resistors, capacitors etc. the respective wave resistance R1, R2 or R3 of the port is determined by the respective element. However, when modeling circuits a situation may occur where a port of an adaptor connects to a further adaptor. In this case, the wave resistance can be matched to one of both sides, and reflections may be avoided. An example is shown in FIG. 11, FIG. 11A showing a symbol and FIG. 11B showing a possible implementation. As can be seen, compared to FIG. 10B by the matched termination the implementation as illustrated in FIG. 11B is simplified, and only a multiplication with one parameter γ₁ is necessary. γ₁ may be calculated according to

$$\begin{matrix}{γ}_{1} = \frac{{G}_{1}}{{G}_{3}} , \\ with & ( 7 ) \\ {G}_{3} = {G}_{1} + {G}_{2} . & ( 8 )\end{matrix}$$

Equation (8) corresponds to the requirement for matching.

Another type of adaptor which will be used in the modeling example of the circuit of FIG. 5 is a three-port serial adaptor with matched termination. FIG. 12A shows a symbol, and FIG. 12B shows a possible implementation. Similar to the parallel adaptor with matched termination, one multiplication with a parameter −γ₁ is necessary. γ₁ may be calculated according to

$$\begin{matrix}{γ}_{1} = \frac{{R}_{1}}{{R}_{3}} , \\ with & ( 9 ) \\ {R}_{3} = {R}_{1} + {R}_{2} . & ( 10 )\end{matrix}$$

Equation (10) is the matching requirement. As can be seen in FIG. 12 and as highlighted by grey shades, b₃ is independent from a₃, thus simplifying the calculation.

In other embodiments, other adaptors, for example three-port serial adaptors without matched terminations, may be used.

Next, implementation of capacitors, inductors and resistors in wave digital filter models will be described. FIG. 13A shows a circuit diagram of a capacitor C, and FIG. 13B shows a corresponding component for a wave digital filter representation, which may be coupled to a port of an n-port adaptor. As can be seen, the capacitor transforms to a delay element of one time unit (z⁻¹ indicating a delay in the z transform domain). A corresponding wave impedance for this element (which for example may be used as R1, R2 or R3 for the three-port adaptors discussed with reference to FIGS. 10-12) is

$${R}_{L} = \frac{{T}_{S}}{2 C} \qquad ( 11 )$$

wherein R_{L} is the wave impedance, C is the capacitance of the capacitor and T_{S} is the duration of a sampling time period (one discrete time step) of the wave digital filter model.

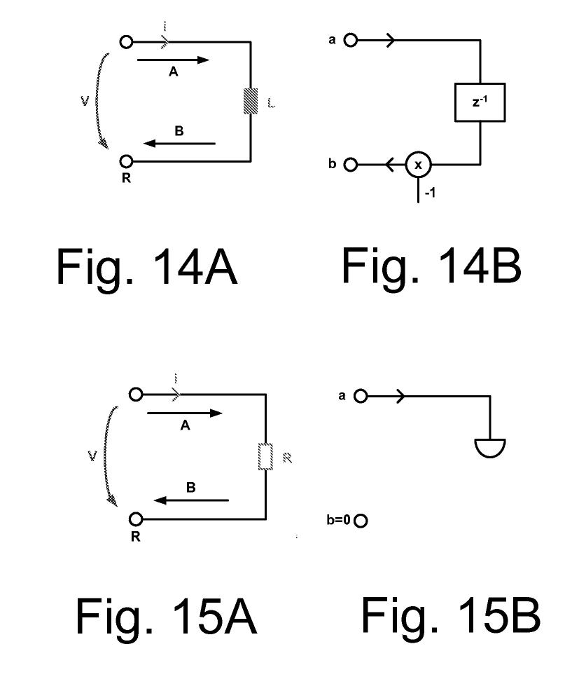

In FIGS. 14A and 14B, implementation of an inductivity in a wave digital filter model is illustrated. FIG. 14A shows a circuit diagram, and FIG. 14B shows a corresponding part of a wave digital filter model. As can be seen in FIG. 14B, the inductor becomes an inverted delay, the inversion being represented by a multiplication by −1 in FIG. 14B. The wave impedance R_{L} in this case is

$${R}_{L} = \frac{2 L}{{T}_{S}} \qquad ( 12 )$$

wherein L is the inductivity of the inductor.

In FIGS. 15A and 15B, implementation of a resistor is illustrated. FIG. 15A shows a circuit diagram with a resistor, and FIG. 15B shows a corresponding wave digital filter implementation. The resistor in the wave digital filter implementation is an ideal termination of the transmission line, i.e. the forward traveling wave a is dumped or terminated. The wave impedance R_{L} in this case is

R_{L}=R (13)

R being the resistance of the resistor.

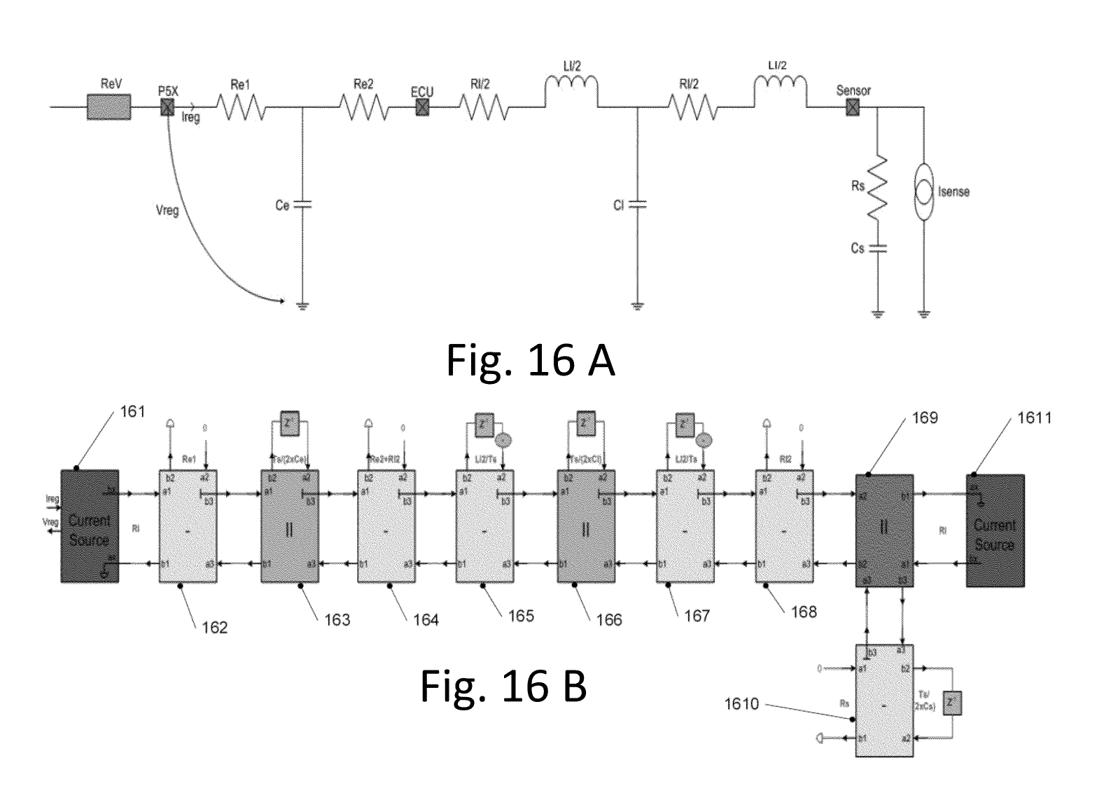

With the elements shown so far, a wave digital filter implementation of the circuit of FIG. 5 may be provided. This is illustrated in FIG. 16. In FIG. 16, for easy reference the example circuit of FIG. 5 is reproduced again. Furthermore, a wave digital filter model of this circuit including current sources 161, 1611 and port adaptors 162-1610 is illustrated.

The current output at node P5X to generate the regulated voltage Vreg is represented by a current source 161. Resistor Re1 in wave digital form is coupled to a matched serial three-port adaptor 162. Capacitor Ce, which is connected in parallel, is represented by a delay element coupled to a matched parallel three-port adaptor 163. Resistors Re2 and RI/2 directly following Re2 are represented as a single wave digital filter resistor coupled to a matched serial three-port adaptor 164. The first inductivity LI/2 (in FIG. 16 represented on the left side of capacitor CI) is coupled to a matched three-port adaptor 165 in wave digital form (inverted delay). Capacitor CI, which is coupled in parallel, is represented in wave digital form as a delay coupled to a matched three-port adaptor 166. The second inductivity LI/2 is represented by an inverted delay coupled to a serial three-port adaptor 167. The second resistor RI/2 is represented by a termination coupled to a three-port serial adaptor 168, as shown. It should be noted that in some instances, the order of the real port adaptors may also be exchanged.

For the representation of the sensor, the current source Isense is represented as a current source 1611 in the wave digital filter model. Current source 1611 is coupled with three-port adaptor 168 via a non-matched parallel three-port adaptor 169. Furthermore, a serial matched three-port adaptor 1610 is coupled to three-port adaptor 169 for implementing the serial connection of resistor Rs and capacitor Cs, which are represented as a termination and delay in FIG. 16, respectively.

Therefore, with the various elements discussed with reference to FIGS. 6-15, the circuit of FIG. 5 may be modeled as a wave digital filter, to be used for example in state observer 12 of FIGS. 1 and 2. In this case, the state observer is implemented using a plurality of port adaptors, for example three-port adaptors, coupled with each other and with wave digital representation of resistors, inductivities, capacitors and current sources. In other embodiments, other implementations of wave digital filters may be used.

Estimated internal states may for example comprise currents or voltages at the various elements of the RLC network of FIGS. 5 and 16. For example, if voltages or currents indicate that a high amount of energy is stored in inductivities or capacitances, V_{reg} may be chosen to be lower than it would be done without knowledge of the internal states.

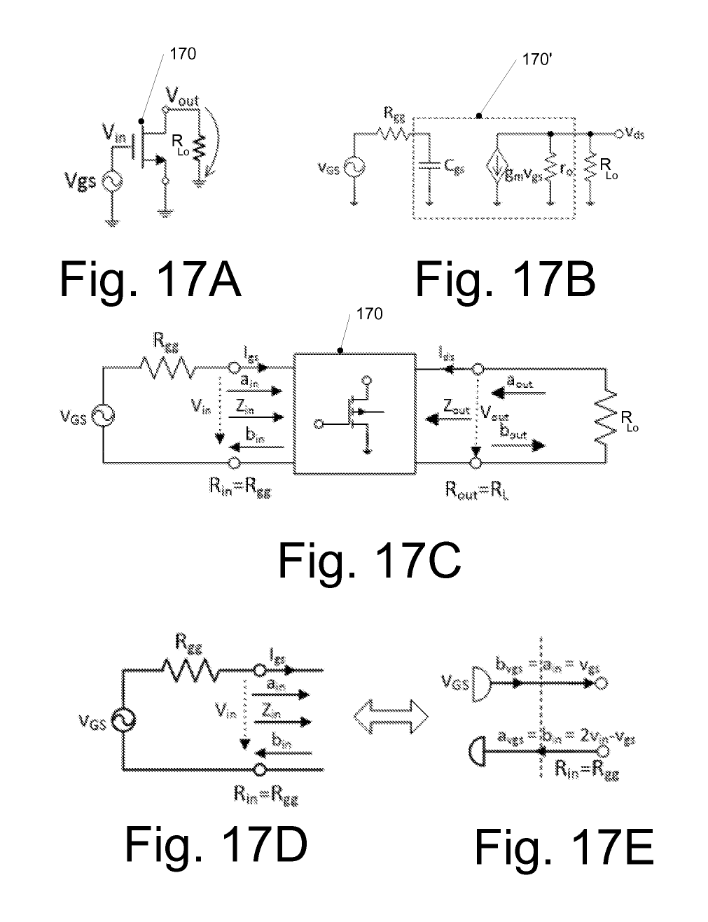

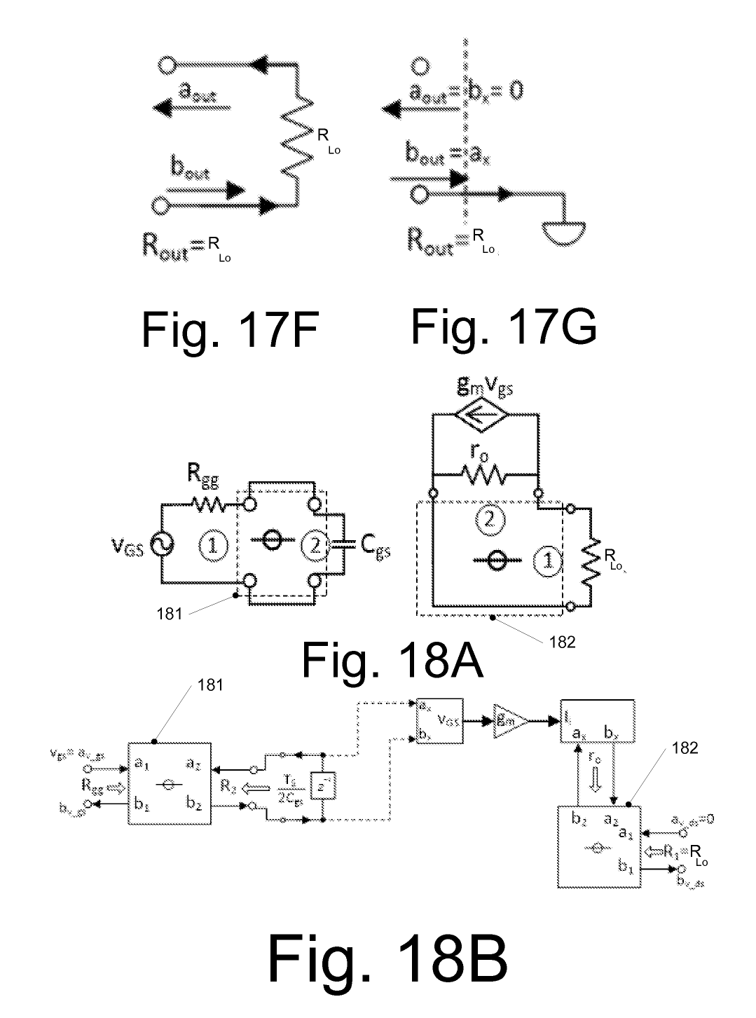

In the above example, a passive network using resistors, inductivities and capacitances has been modeled as a wave digital filter, for use in a state observer. In other embodiments, for example circuits including transistors may be modeled. This will now be explained with reference to FIGS. 17-27.

In embodiments, small signal models are used to model transistors or other non-linear elements may be used. A small signal model may interrelate incremental changes in a drain current i_{D}, a gate-source voltage v_{GS} and a drain-source voltage v_{DS} of a transistor. With small changes, a small signal equivalent circuit may be built using only linear elements like capacitors, resistors and controlled current sources, which may be modeled using wave digital filters as has already been explained above. To illustrate further, in the following various wave digital filter representations of NMOS transistors will be discussed. Corresponding techniques may also be applied to other types of transistors, for example PMOS transistors.

Generally, as will now be explained with reference to FIGS. 17A-17G, an NMOS transistor may be seen as a two-port network. To illustrate this, FIG. 17A shows an NMOS transistor 170. A gate terminal of NMOS transistor receives an input voltage Vᵢₙ, which in this case corresponds to a gate source voltage V_{ds}, applied by a voltage source. A source terminal of NMOS transistor 170 is coupled to ground, and a drain terminal outputs an output voltage Vₒᵤₜ to a load, represented by a resistor R_{Lo} as shown. FIG. 17B shows a small signal model. The voltage source for the gate source voltage is represented by a “pure voltage source” and an internal resistance R_{gg}, coupled with a gate source capacitance C_{gs} of the small signal model 170′. Furthermore, an output voltage is generated by a voltage source depending on the gate source voltage as illustrated by a gain factor gₘ. An internal output resistance is labeled rₒ.

The values of the parameters, in particular the value of gₘ, may depend on an operating point of the transistor.

FIG. 17C shows transistor 170 as a two-port adaptor representation with wave resistances or wave impedances Zᵢₙ and Zₒᵤₜ, forward travelling wave aᵢ on an input port side, backward travelling wave bᵢₙ on the input port side, forward travelling wave aₒᵤₜ on the output port side and backward travelling wave bₒᵤₜ on the output port side.

FIG. 17D shows only the input port side, and FIG. 17E shows a wave digital filter representation of the input port side with a wave source which generates a forward travelling wave aᵢₙ corresponding to the gate source voltage v_{gs} and a wave sink which terminates the backward travelling (incoming) wave bᵢₙ at the internal resistor R_{gg}.

FIG. 17F shows the portion connected to the output port of FIG. 17C, and FIG. 17G shows a wave digital filter representation with a sink only, as discussed previously for resistors.

What remains to be determined then is a representation of transistor 170 itself in wave digital form. First, a wave digital filter model for a transistor in common source connection will be discussed. Here, the small signal model of FIG. 17B may be employed. The control voltage v_{GS} is applied to the internal capacitor C_{gs}. For the waves on the input side, therefore the following equation applies:

v_{GS}=(aₓ_{_{—}}+bₓ_{_{—}}C_{gs})/2, (14)

aₓ_{_{—}}C_{gs} and bₓ_{_{—}}C_{gs}, being the waves at the capacitance C_{gz}. The outgoing waves (as seen in FIG. 17E, the incoming wave is terminated) at the output port side bₓ may be calculated according to

bₓ=−gₘ·(aₓ_{_{—}}C_{gs}+bₓ_{_{—}}C_{gs})·r₀/2. (15)

As illustrated in FIG. 18A, for realization two adaptors are required: one two-port adaptor linking the input part (as illustrated in FIG. 17E) with capacitance C_{gs}, and a real two-port adaptor linking the part shown on the right side of FIG. 18A. This leads to a wave digital filter representation of the transistor as shown in FIG. 18B. The relevant equations of first adaptor 181 are

$${a}_{1} = {v}_{gs} {b}_{1} = {a}_{1} - {γ}_{1} {a}_{0} \\ {a}_{2} = {b}_{2} {z}^{- 1} {b}_{2} = {a}_{2} - {γ}_{2} {a}_{0} \\ {a}_{0} = {a}_{1} + {a}_{2} \\ {y}_{1} = \frac{2 {R}_{gg}}{{R}_{gg} + {R}_{C\_eq}} {R}_{C\_eq} ≫ {R}_{gg} \\ {y}_{2} = \frac{2 {R}_{C\_eq}}{{R}_{gg} + {R}_{C\_eq}} {y}_{1} = \frac{2}{{R}_{c\_eq}} \\ {y}_{2} = 2 \\ {b}_{2} ( z ) = - {b}_{2} ( z ) \cdot {z}^{- 1} - 2 {V}_{gs} ( z ) \\ \begin{matrix}{b}_{x} ( z ) = - {g}_{m} {r}_{0} \cdot \frac{{a}_{2} ( z ) + {b}_{2} ( z )}{2} \\ = - {g}_{m} {r}_{0} \cdot \frac{{b}_{2} ( z ) \cdot {z}^{- 1} - {b}_{2} ( z ) \cdot {z}^{- 1} - 2 {V}_{gs} ( z )}{2}\end{matrix} \\ {b}_{x} ( z ) = {g}_{m} {r}_{0} {V}_{gs} ( z ) \qquad ( 16 )$$

The equations for second two-port adaptor 182 are

$${a}_{1} = 0 {b}_{1} = {a}_{1} - {γ}_{1} {a}_{0} \\ {a}_{2} = {g}_{m} {r}_{0} {v}_{gs} {b}_{2} = {a}_{2} - {γ}_{2} {a}_{0} \\ {a}_{0} = {a}_{1} + {a}_{2} = 0 + {a}_{2} = {a}_{2} \\ {y}_{1} = \frac{2 {R}_{L}}{{r}_{0} + {R}_{L}} \\ {y}_{2} = \frac{2 {r}_{0}}{{r}_{0} + {R}_{L}} \\ {b}_{2} ( z ) = - 2 \cdot {g}_{m} \cdot ( {r}_{0} \vert \vert {R}_{L} ) {V}_{gs} ( z ) \qquad ( 17 )$$

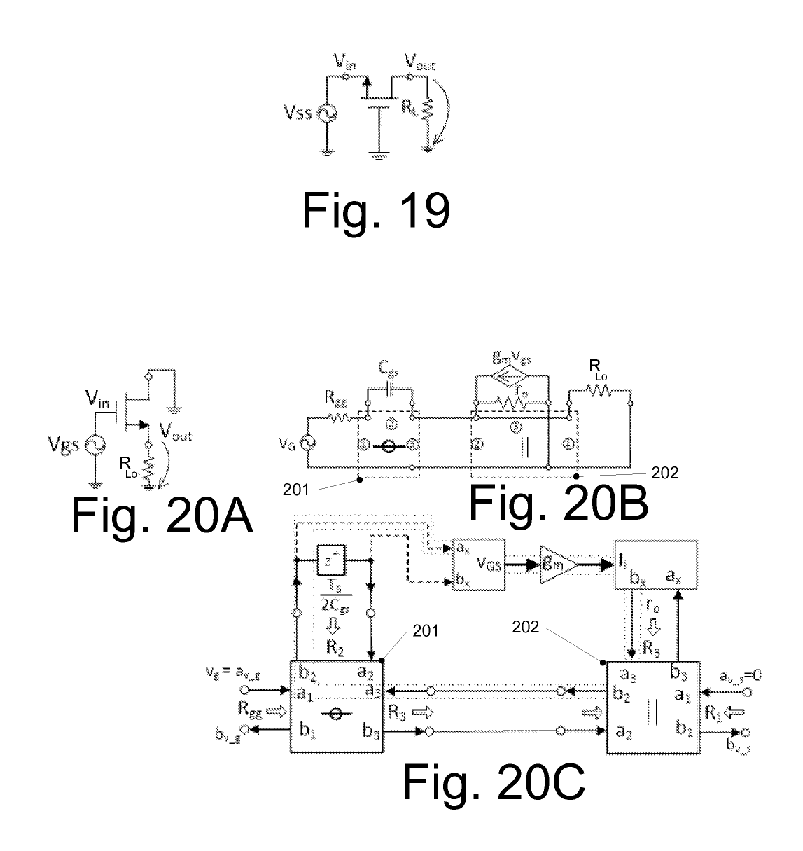

A similar approach may be taken for a common gate connection of a transistor, as illustrated in FIG. 19.

A further example which will be handled in some more detail is shown in FIG. 20A, illustrating a common drain connection of a transistor. FIG. 20B shows a small signal model with indicated adaptors 201, 202, which are both three-port adaptors. FIG. 20C shows a wave digital filter representation of a transistor in common drain connection using a small signal model. The relationship between the wave may be written as a set of equations \vec{b}=\vec{S}*\vec{a}, with

$${b}_{11} = - {b}_{22} {γ}_{11} + {b}_{31} {γ}_{11} + {v}_{gs} \\ {b}_{21} = - {b}_{22} {γ}_{21} + {b}_{31} {γ}_{21} + \frac{{b}_{21}}{z} \\ {b}_{31} = - {v}_{gs} - \frac{{b}_{21}}{z} \\ {b}_{12} = \frac{( \frac{1}{z} + 1 ) {b}_{21} {g}_{m} {γ}_{32} {r}_{0}}{2 z} + {b}_{31} {γ}_{22} \\ {b}_{22} = {b}_{12} - {b}_{31} \\ {b}_{32} = \frac{( \frac{1}{z} + 1 ) {b}_{21} {g}_{m} {r}_{0}}{2 z} + {b}_{12} . \qquad ( 18 )$$

For the bᵢⱼ, i indicates the port of the adaptor (1, 2 or 3), and j indicates the adaptor (first adaptor 201 or second adaptor 202).

Above, relatively simple small signal models have been used, which may be sufficient for some applications. Also, more complex small signal models taking more internal capacitances like a gate drain capacitance into account may be used.

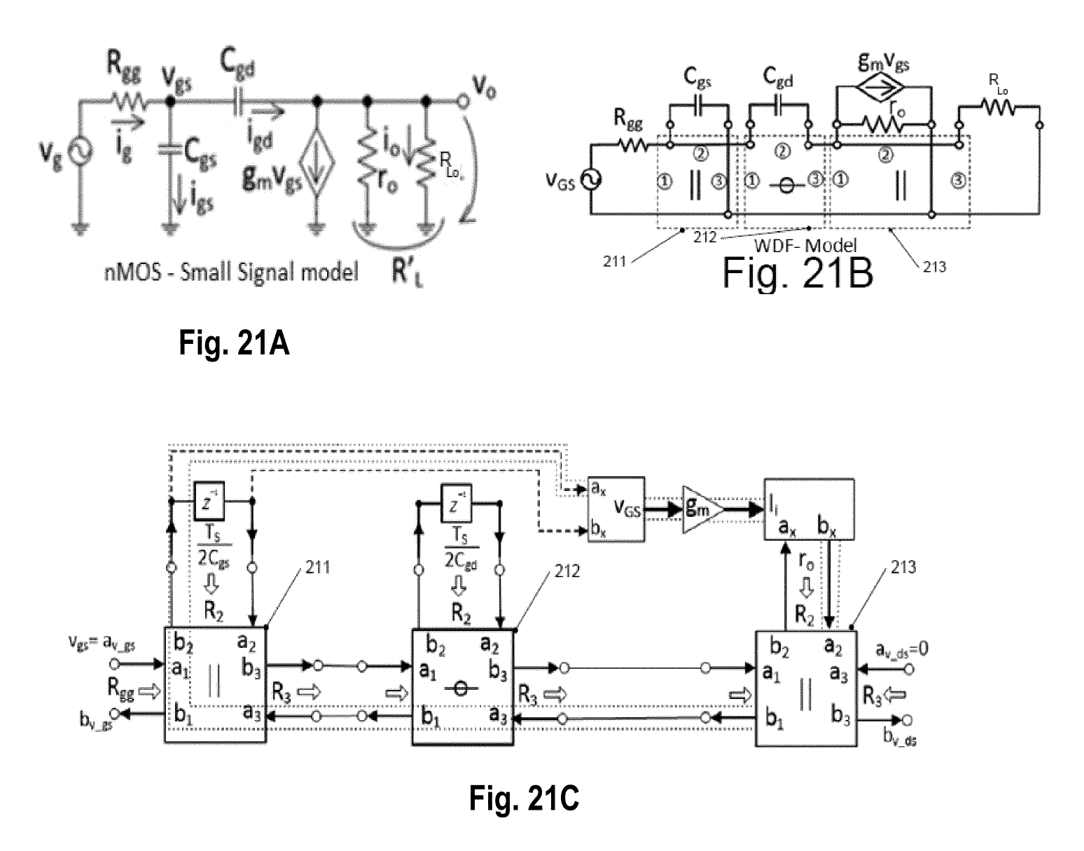

For example, in FIGS. 21A-21B a model with a common source connection where besides a gate source capacitance C_{gs} also a gate drain capacitance C_{gd} is taken into account and is illustrated. FIG. 21A illustrates a small signal model, FIG. 21B illustrates the location of three adaptors 211, 212 and 213, and FIG. 21C shows the wave digital filter model.

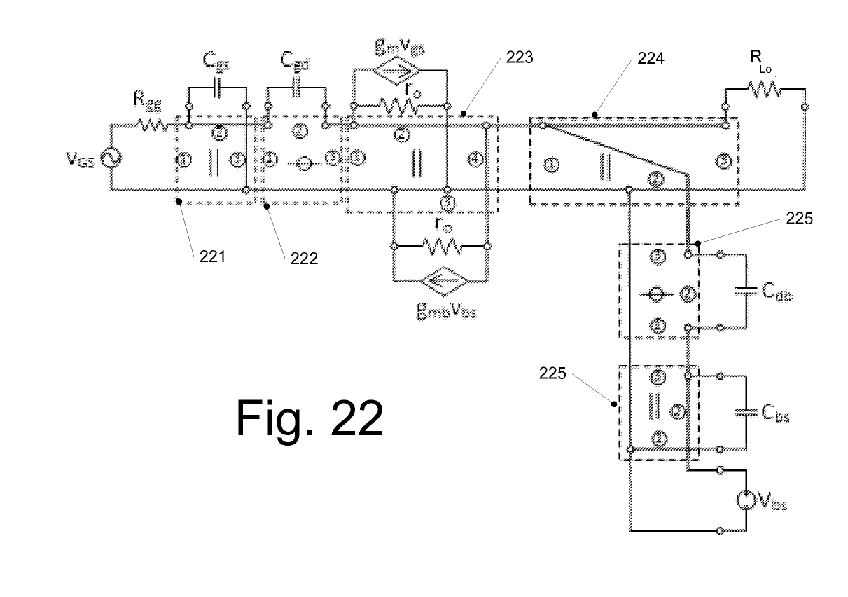

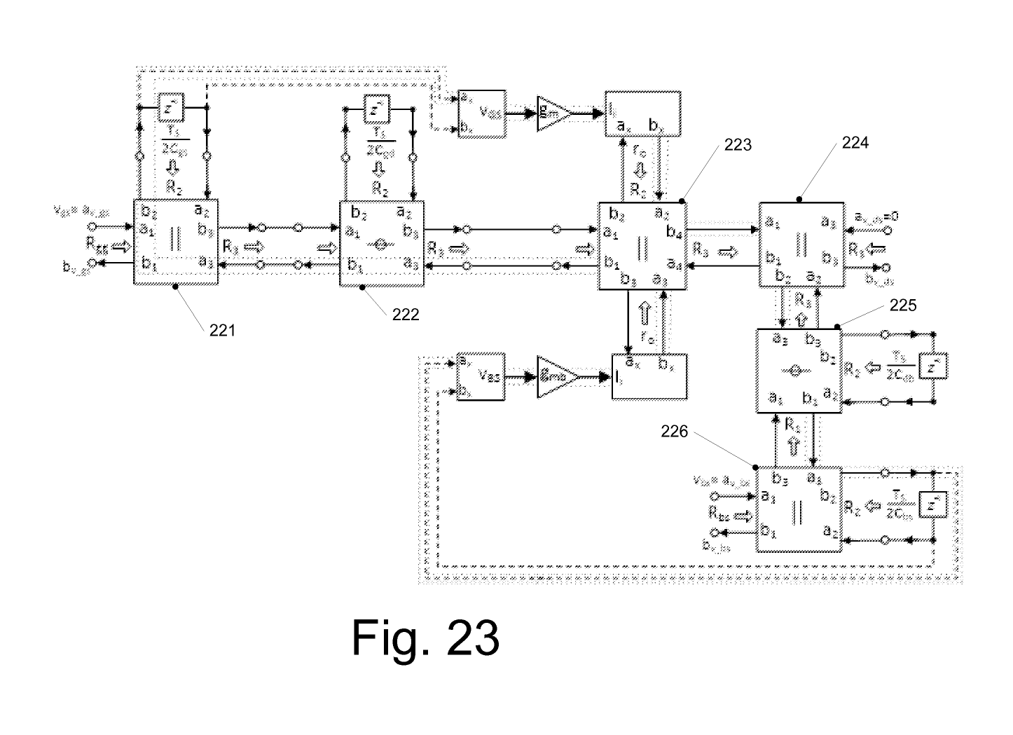

FIGS. 22 and 23 show a further example for modeling a common source connection, in this case including a bulk potential (modeled by g_{mb}·v_{bs}), a drain bulk capacitance C_{db} and a bulk source capacitance C_{bs}. FIG. 22 shows a small signal model including locations of three-port adaptors 221-226, and FIG. 23 illustrates a corresponding wave digital filter model.

Generally, when modeling transistors comparatively small delays may be introduced, and delays may be a multiple of a sampling period.

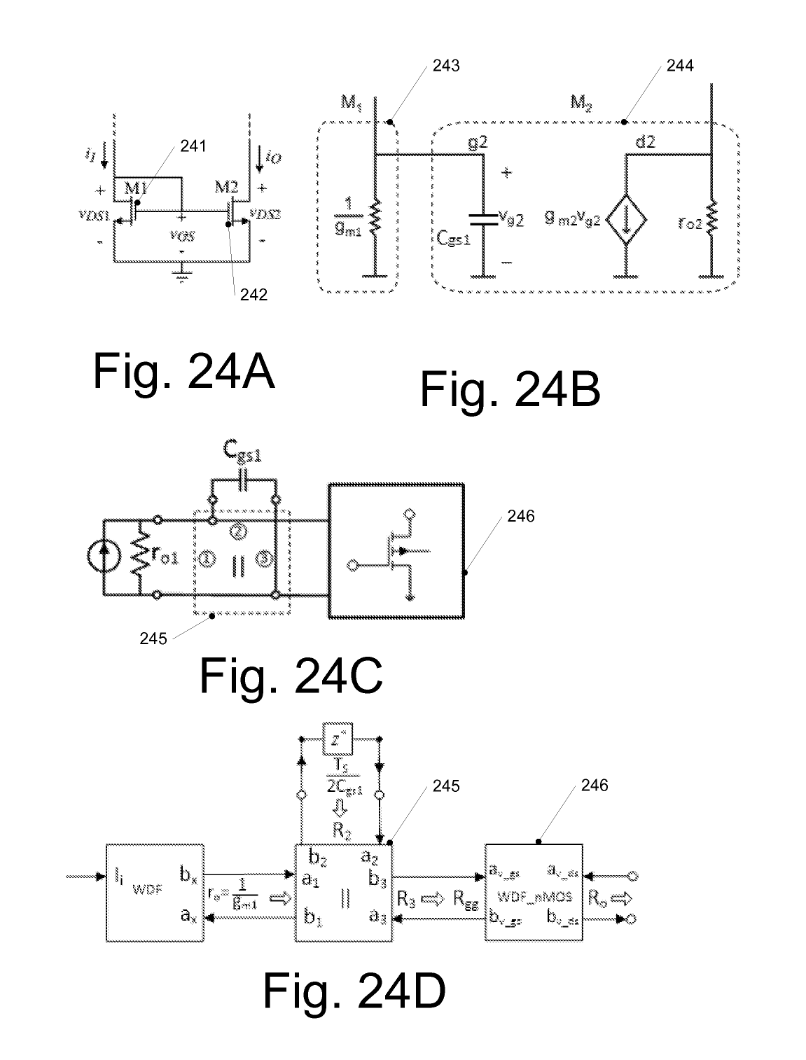

On the basis of transistor modeling, for example current mirrors may be modeled. FIG. 24A illustrates an example for a simple current mirror with two transistors 241, 242. Transistor 241 is provided in a diode connection. FIG. 24B shows an example for a small signal equivalent circuit usable for wave digital filter modeling. 243 includes a model for a diode (modeling transistor 241 of FIG. 24A), and 244 includes a model of a transistor (thus modeling transistor 242), essentially corresponding to the small signal circuit discussed already with respect to FIG. 17B. Diode 243 may be modeled by a voltage source with an internal resistance rₒₗ. FIG. 24C shows the configuration with the location of a parallel three-port adaptor 245 and a transistor model 246 (corresponding to or modeling transistor 242). FIG. 24D illustrates a wave digital filter model of the current mirror. 247 represents a wave digital filter model of an NMOS transistor, as discussed previously with respect to FIGS. 17-23, for example the representation illustrated in FIG. 18B.

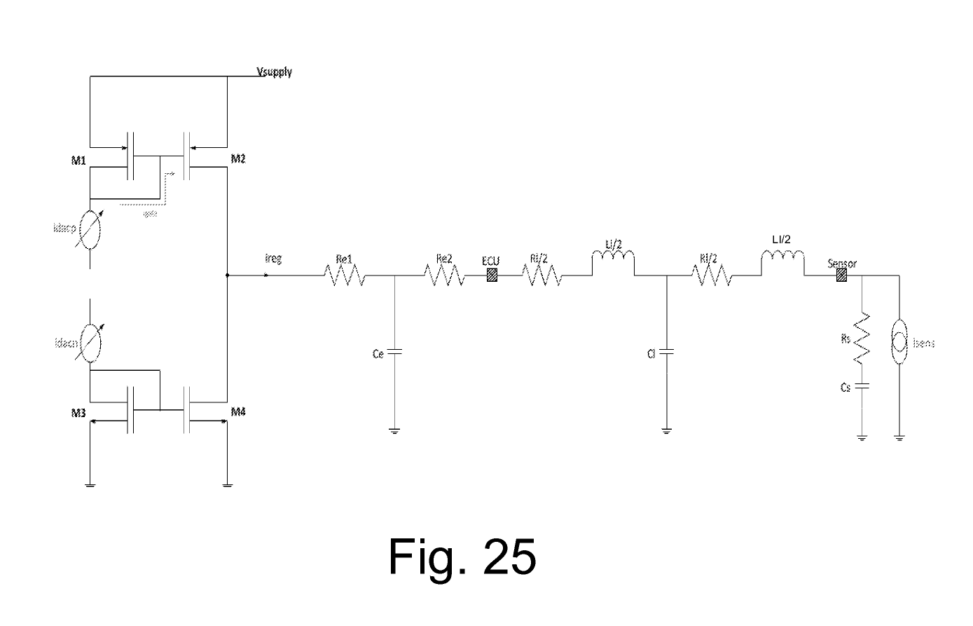

Using such current mirrors, for example a wave digital filter model of the system of FIG. 4 including regulator loop 46, internal load 47, external load 42 and sensor 43 may be provided. A corresponding circuit diagram is shown in FIG. 25. Regulator loop 46 is represented by two current sources IDACP, IDACN and two current mirrors, a first current mirror being formed by PMOS transistors M1, M2 and a second current mirror being formed by NMOS transistor M3, M4. The remaining elements shown in FIG. 25 have already been discussed with reference to FIG. 5 and represent internal load 47, external load 42 and sensor 43, as explained with reference to FIG. 5.

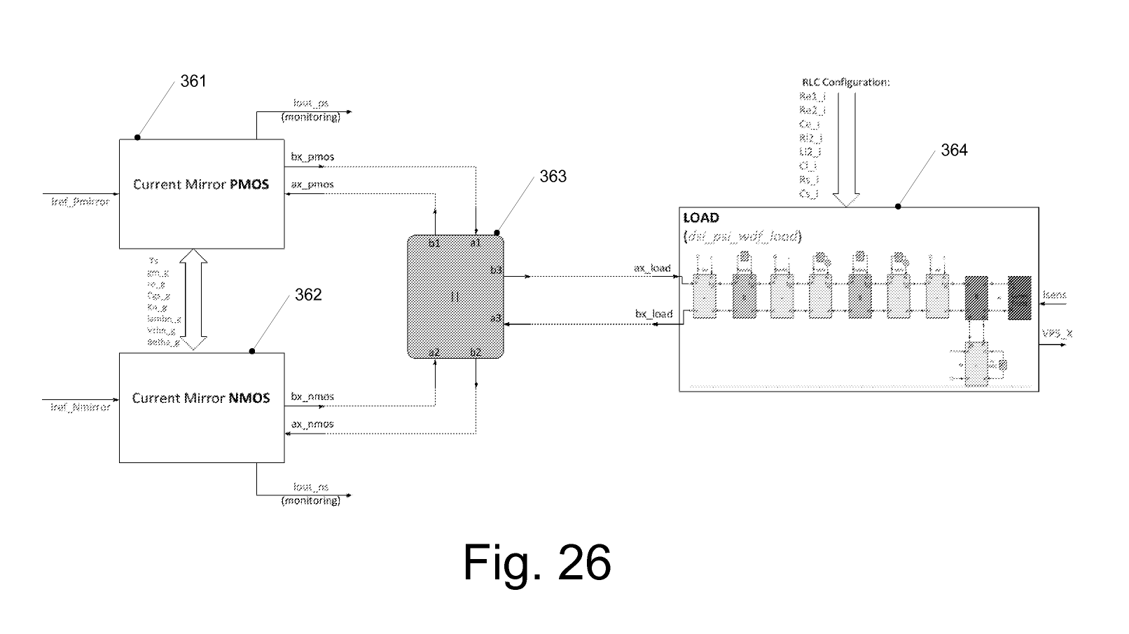

In FIG. 26, a corresponding wave digital filter representation is shown. A part 364 of the wave digital filter representation corresponds to the part already discussed with reference to FIG. 16. Furthermore, the wave digital filter model includes a PMOS current mirror 361 (representing transistors M1, M2 of FIG. 25) and an NMOS current wave digital filter representation 362 (representing M3 and M4). The current mirror wave digital filter models 361, 362 may essentially be implemented as discussed with reference to FIG. 25. Wave digital filter models 361, 362 and 364 are coupled together via a three-port adaptor 363.

Therefore, using an example it has been illustrated above that also control devices including non-linear elements like transistors may be modeled using wave digital filters to provide a state observer, for example for a control system as illustrated with reference to FIGS. 1 and 2. Such state observers may comprise a plurality of n-port adaptors coupled with each other and coupled with simple one-port elements representing for example resistors, inductivities, capacitances, current sources, closed connections or open connections, as discussed in detail previously.

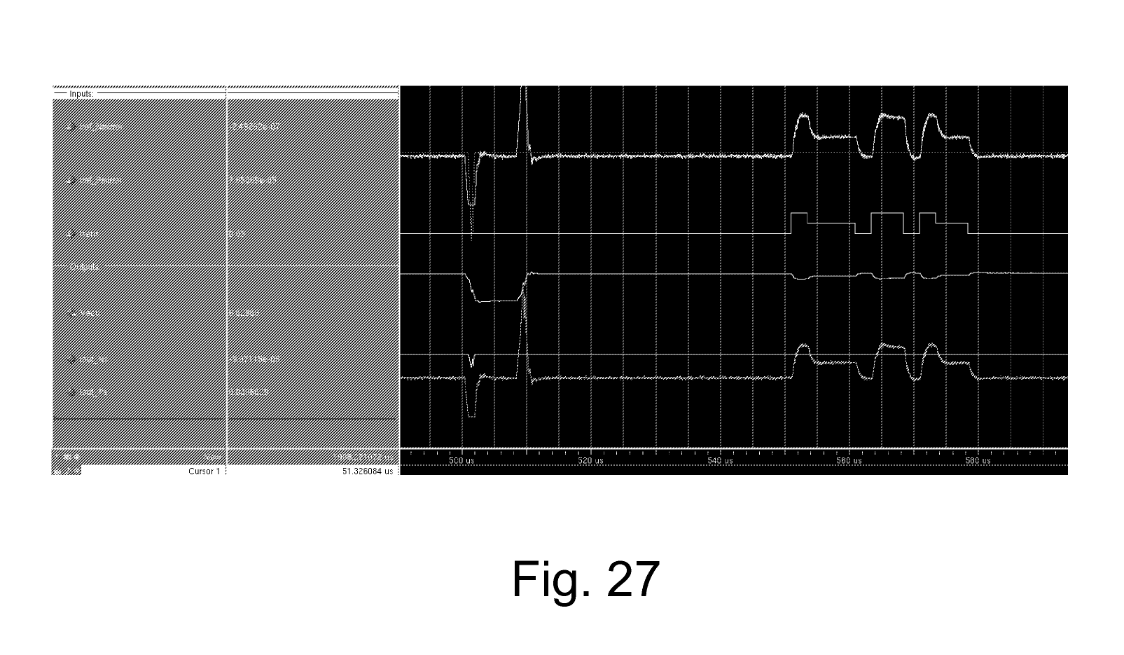

In FIG. 27, a simulation example for the wave digital filter model of FIG. 26 is illustrated. As can be seen, a stable simulation behavior may be obtained.

Using wave digital filters, generally state observers may be implemented having a minimum number of delay elements for a given filter specification. In some embodiments, good properties with respect to stability and sensitivity may be obtained. In some example embodiments, low and microcontrollers, i.e. microcontrollers with comparatively small computing power, may be used for implementing the wave digital filters. Generally, while specific examples have been shown for wave digital filter model implementations, the concepts discussed herein may be applied to a broad variety of devices to obtain corresponding state observers, as evident to persons skilled in the art. Therefore, the discussed embodiments are not to be construed as limiting the scope of the present application in any way.

1: A system, comprising:
a controller, the controller being adapted to output a control signal, and
a state observer adapted to estimate internal states of a controlled device, the state observer comprising a wave digital filter model of at least part of the controlled device,
the controller being adapted to generate the control signal based on the estimated internal states.

2: The system of claim 1, wherein the controller is further adapted to receive a feedback signal from the controlled device, the controller being adapted to generate the control signal based on the feedback signal.

3: The system of claim 1, further comprising a parameter estimator adapted to adjust parameters of the wave digital filter model based on a comparison of an output of the controlled device and an internal wave digital filter state that corresponds to the output of the controlled device.

4: The system of claim 3, wherein the estimated internal states comprise at least one of the adjusted parameters.

5: The system of claim 1, further comprising the controlled device, wherein the controlled device is adapted to receive the control signal.

6: The system of claim 1, wherein the wave digital filter model comprises at least one of a wave digital filter model of a RLC network, a model of at least one transistor based on a small signal model of the transistor or wave digital filter model of a current mirror.

7: The system of claim 1, wherein the wave digital filter model comprises a wave digital filter model of a sensor.

8: The system of claim 1, wherein the wave digital filter model comprises a plurality of n-port adaptors.

9: The system of claim 8, wherein the n-port adaptors comprise at least one three-port serial adaptor.

10: The system of claim 8, wherein the plurality of n-port adaptors comprises at least one three-port parallel adaptor.

11: The system of claim 1, wherein the estimated internal states comprise at least one of an internal current or an internal voltage.

12: A state observer, comprising a wave digital filter model of at least part of a device.

13: The state observer of claim 12, wherein the wave digital filter model comprises a plurality of n-port adaptors.

14: The state observer of claim 12, wherein the wave digital filter model models at least one of a wire harness or a sensor.

15: The state observer of claim 12, wherein the wave digital filter model models a current mirror.

16: A method, comprising:
estimating internal states of a device based on a control signal using a wave digital filter model of at least part of a device, and
generating the control signal based on the estimated internal states.

17: The method of claim 16, further comprising repeating the generating and the estimating to implement a control loop.

18: The method of claim 16, further comprising generating a device feedback by the device based on the control signal, wherein the generating of the control signal is furthermore based on the device feedback.

19: The method of claim 16, wherein the device comprises a sensor.

20: The method of claim 16, wherein the wave digital filter model comprises a plurality of n-port adaptors.
